(19) United States
(12) Patent Application Publication
(10) Pub. No.: US 2021/0269132 A1
(43) Pub. Date: Sep. 2, 2021

(54) FLUID MACHINE WITH IMPELLER DRIVEN VIA ITS RIM

(71) Applicant: FLOWTRU AS, BØLANDET (NO)

(72) Inventor: Martin Jung LEINE, BØLANDET (NO)

(21) Appl. No.: 17/255,754

(22) PCT Filed: Jun. 11, 2019
(86) PCT No.: PCT/NO2019/050118

§ 371 Date: Dec. 23, 2020

(30) Foreign Application Priority Data
Jun. 29, 2018 (NO) 20180926

(51) Int. Cl. B63H 1/28; F03B 17/06; F04D 13/02; F04D 13/08; F04D 29/046; F04D 29/10; F04D 29/18

(52) U.S. Cl. CPC B63H 1/28; F03B 17/061; F04D 13/021; F04D 13/086; F04D 29/046; F05B 2240/931; F04D 29/181; F05B 2220/20; F05B 2220/706; F05B 2240/50; F04D 29/106

(57) ABSTRACT

A fluid machine (1) having an intake part (21), a discharge part (26), and an impeller (24), the impeller (24) being arranged in an enclosure (18), and a transmission (90) arranged in the enclosure (18) and operationally connecting a rim (11) of the impeller (24) with an energy converter (2,2′).

The present disclosure relates to fluid machines. Some embodiments provide fluid machines usable as pumps or turbines in various applications.

### BACKGROUND

Various solutions exist for fluid machines for applications such as pumps, e.g. for pumping of live fish in fish farming; turbines, e.g. turbines for use in micro- and mini power plants in rivers, streams or ocean currents; thrusters for maneuvering and propulsion of ships; fans; blowers or similar applications.

Publications which may be useful to understand the background include US 2005/0284394 A1; GB 1172179 A; GB 2042641 A; CN 201943973 U; and WO 91/18501 A1.

There is nevertheless a need for improved technology in relation to fluid machinery in general, and to fluid machines for particular, specialist applications. The present invention has the objective to provide fluid machines which provide advantages or alternatives to known solutions.

### SUMMARY

In an embodiment, there is provided a fluid machine having an intake part, a discharge part, and an impeller, the impeller being arranged in an enclosure, and a transmission arranged in the enclosure and operationally connecting a rim of the impeller with an energy converter.

Further embodiments are described in the appended claims and in the detailed description below.

### BRIEF DESCRIPTION OF THE DRAWINGS

These and other characteristics will become clear from the following description of illustrative embodiments, given as non-restrictive examples, with reference to the attached drawings, in which

FIG. 1 is a partially cut perspective view of a fluid machine according to an embodiment,

FIG. 2 is an exploded view of parts of the fluid machine shown in FIG. 1,

FIG. 3 is a partially cut perspective view of parts of the fluid machine shown in FIG. 1,

FIG. 4 is a cut, side view of the fluid machine shown in FIG. 1,

FIGS. 5A and 5B are partially cut perspective views of a fluid machine according to an embodiment,

FIG. 6 is a cut, side view of the fluid machine shown in FIG. 5A,

FIG. 7 illustrates a fluid machine according to another embodiment,

FIG. 8 illustrates a fluid machine according to another embodiment,

FIG. 9 illustrates a fluid machine according to another embodiment,

FIG. 10 illustrates a fluid machine according to another embodiment.

FIGS. 11a and 11b illustrate certain optional aspects of fluid machines according to embodiments described,

FIGS. 12a and 12b illustrate certain optional aspects of fluid machines according to embodiments described, and

FIGS. 13a and 13b illustrate an application of a fluid machine according to an embodiment.

### DETAILED DESCRIPTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

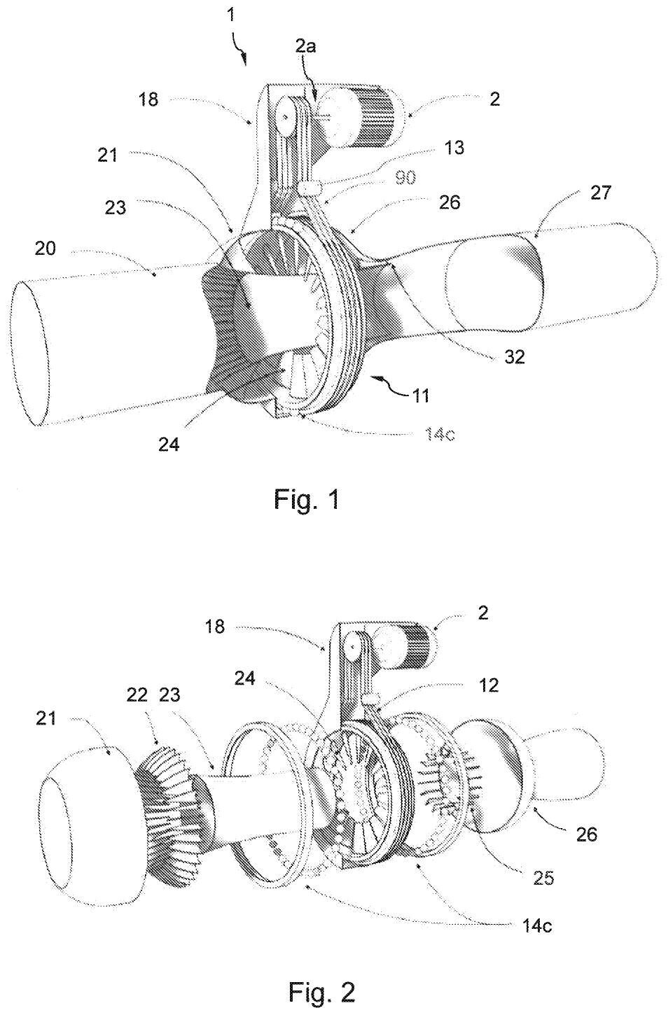

In one embodiment, FIGS. 1-4 show various aspects of a fluid machine 1 arranged for use as a fish pump. Such a fish pump may, for example, be used for moving fish in a fish farming plant and/or between a fish farm and the cargo hold in a well boat.

Referring to FIGS. 1-3, the fluid machine 1 has a driveline enclosure 18, and an intake part 21 and a discharge part 26 of the enclosure 18. In this embodiment, the intake part 21 and the discharge part 26 are connected to the enclosure 18 and coupled to pipes 20,27 extending from the enclosure 18 in opposite directions. An intake pipe 20 is arranged to provide an intake fluid flow to the fluid machine 1, and a discharge pipe 27 is arranged to lead a discharge fluid flow away from the fluid machine 1. The intake part 21 and the discharge part 26 may be part of the enclosure 18, or they may be connected to the enclosure 18 via a connection which may be, for example, a bolted connection, an interference fit connection, or another type of connection.

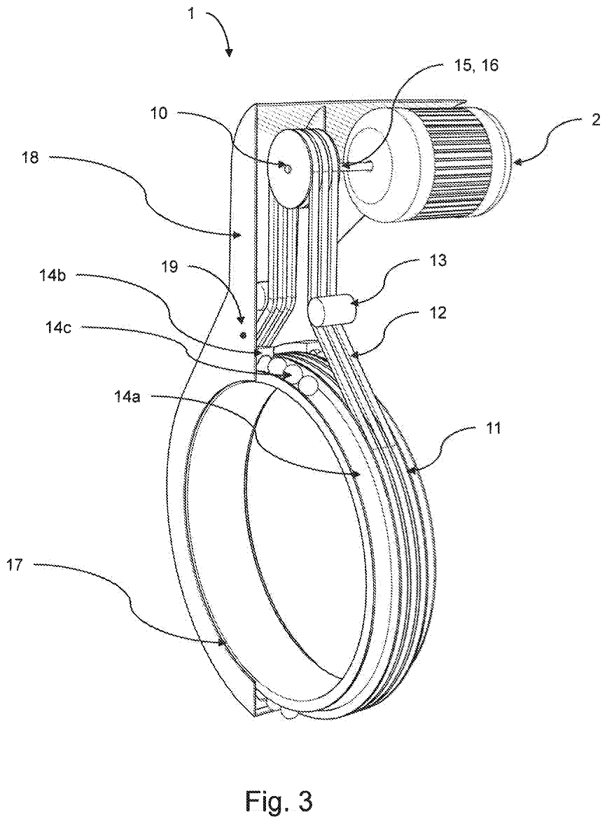

An impeller 24 is arranged in the enclosure 18, and a driveline 90 is also arranged in the enclosure 18 and operationally connecting a rim 11 of the impeller 24 with a prime mover 2. Operating the prime mover 2 thus causes a rotation of the impeller 24. In this embodiment, the driveline 90 is a belt drive. As most clearly illustrated in FIG. 3, a sheave 10 connected to the prime mover 2 drives a drive belt 12 which is arranged on a second sheave which in this embodiment is integrated with the impeller rim 11. Belt tensioners 13 may be used to maintain the required belt tension. In this embodiment, a bearing inner race 14a is integrated with the impeller rim 11 and a bearing outer race 14b is carried by a support structure or the enclosure 18.

Also shown in FIGS. 1-3 are bearings 14c to support the impeller 24. The bearings 14c may be arranged within the enclosure 18, and be liquid-lubricated bearings which operate in the process fluid, for example water being pumped through the fluid machine 1. The bearings 14c may be ball bearings, as illustrated in FIGS. 1-3, roller bearings (e.g. conical rollers), or alternatively other types of bearings such as hydrodynamic bearings or a combination of different types of bearings. The bearings 14c may thus operate on the rim 11 to carry axial (thrust) and/or radial loads. The bearings 14c may be configured to operate fully submerged in the process fluid, whereby in certain embodiments no special lubrication may be required.

The impeller 24 may for this purpose have integrated surfaces for the drive belt 12 arranged on its outer perimeter/rim 11. Alternatively, the driveline 90 may be a chain drive, or any other suitable transmission operating on the rim 11 of the impeller 24. Alternatively, the driveline 90 may be a gear drive, for example by means of a first gear arranged on the shaft 2a of the prime mover 2 engaging a toothed outer surface of the rim 11 (i.e. such that the impeller 24 acts as a second gear in the driveline 90). The relative size of the sheave 10 (or equivalent gear, if using a gear transmission) to the rim 11 outer diameter can be designed such as to obtain desired operating speeds of the system components.

In the embodiment illustrated in FIGS. 1-3, the belt 12 may, for example, be a V-belt running in grooves integrated in the impeller rim 11 and in the sheave 10 of the prime mover 2. In the illustrated embodiment, three parallel belts are used. This may, for example, increase torque transfer capacity. The belt or belts may also be toothed for the same purpose.

The prime mover 1 is in this embodiment an electric motor, but may in any of the embodiments described herein be, for example, a hydraulic motor, a pneumatic motor, or any other machine operable to deliver rotary power. The prime mover 1 is located outside the enclosure 18, and a shaft bearing 15 and shaft seal 16 are arranged to support and seal against the shaft of the prime mover 1 extending into the enclosure 18 and to the sheave 10. The shaft seal 16 may, for example, be a labyrinth seal, a lip seal or a face seal around the shaft 2a of the prime mover 2. The shaft seal 16 may thus isolate the prime mover 2 from any fluid inside the enclosure 18.

A labyrinth seal 17 (or a different type of seal or constriction) may be arranged at the impeller rim 11 to partly or fully isolate the interior of the enclosure 18 from the process fluid flowing through the fluid machine 1. This may help reduce pollution of the bearings 14c and the driveline 90. The constriction or labyrinth seal 17 thus prevents particles, debris or other undesired elements from reaching the engagement surfaces of the bearings 14c and/or the components of the driveline 90. The constriction or labyrinth seal 17 may thus at least partially separate the interior of the enclosure 18 from the annular volume 31.

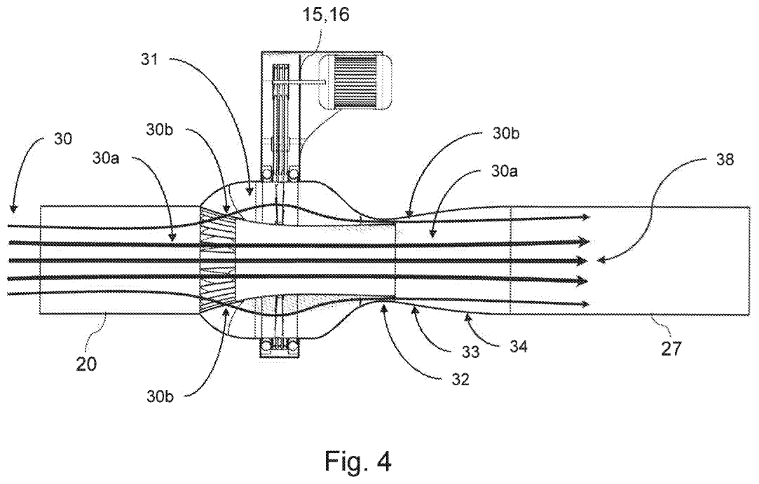

The impeller 24 in this embodiment has an open centre section and is arranged in an annular volume 31 (see FIG. 4) around a duct 23, which protrudes through the open centre impeller 24. The duct 23 may be made up of a pipe in a suitable material, such as a natural or synthetic polymer, a composite, or a metal. As is most clearly visible in FIG. 4, the duct 23 defines a first fluid path through the fluid machine 1, between the intake pipe 20 and the discharge pipe 27. The duct 23 and the enclosure 18 further define a second fluid path through the annular volume 31, via the impeller 24, and to an annular nozzle 32 downstream the impeller 24. In this embodiment, the inlet and outlet to the second fluid path is thus located on each side of the duct 23. The annular nozzle 32 discharges into a throat section 33 downstream the duct 23.

When operating the prime mover 14, a fluid flow is thus generated through the fluid machine 1, whereby an intake flow 30 is separated in a first flow 30b through the annular volume 31, and a second flow 30a through the duct 23. In the annular volume 31, the impeller 24 accelerates the first fluid flow 30b. Downstream the annular nozzle 32, the high-velocity fluid flow 30b from the annular volume 31 creates a pressure reduction at the throat section 33 (a “suction effect”), thereby generating the first fluid flow 30a through the duct 23. The duct 23 thus provides a restriction-free passage for fish or other non-fluid elements via fluid flow 30a.

The first and second fluid flows 30a,b are joined in a diffuser section 34, whereby a uniform outlet flow 38 is created in the discharge pipe 27.

A grid 22 (see FIGS. 1 and 2) may be arranged to prevent solids or non-fluid elements, such as fish, from entering the annular volume 31. The grid 22 may, alternatively or at the same time, be designed as a hydrodynamic element, such as fluid guide vanes, in order to direct the fluid to obtain a beneficial fluid flow pattern into the annular volume 31. For example, individual grid elements may be angled to generate a rotating flow field for the fluid flowing towards the impeller 24. This may improve the efficiency, reduce wear, or in other ways benefit the impeller 24 and associated components. The grid 22 may also serve to fix the duct 23 in the enclosure 18.

As can be seen in FIG. 2, there may further be hydrodynamic elements 25, such as outlet fluid guide vanes, arranged at the annular nozzle 32 or upstream or downstream the annular nozzle to generate a beneficial fluid flow into the throat section 33 and the diffuser section 34. For example, it may be desirable to reduce any rotational flow pattern of the first flow 30b flowing into the diffuser section 34.

In one embodiment, the fluid machine 1 according to the embodiment illustrated in FIGS. 1-4 or those embodiments described below may have an injection nozzle 19 arranged in the enclosure 18, the injection nozzle being configured for injection of fluid from an outside of the enclosure and into an internal volume of the enclosure 18.

For example, the injection nozzle 19 may be used to inject a cleaning agent into the enclosure 18 such as to clean the components therein and the interior surfaces. In a fish pump application, this may for example be part of periodic cleaning of the equipment. In other applications, such as in a thruster drive, the fluid may be one which prevents marine growth. In yet other applications, it may be desirable to inject a gas, steam and/or fluids which provide for example rust inhibition, lubrication or surface treatment of the components in the enclosure 18.

In some embodiments, the injection nozzle 19 can be used during operation of the fluid machine 1, either periodically or continuously or semi-continuously. In some embodiments, the enclosure 18 may, in conjunction with the seal 17 and/or the shaft seal 16, allow the fluids to remain within the enclosure 18 for a prolonged period of time, whereby such fluids can provide an effect over longer time and the need for continuous or repeated injections is reduced. This may for example in a fish pump application relate to fluids to prevent bacterial growth in the enclosure 18.

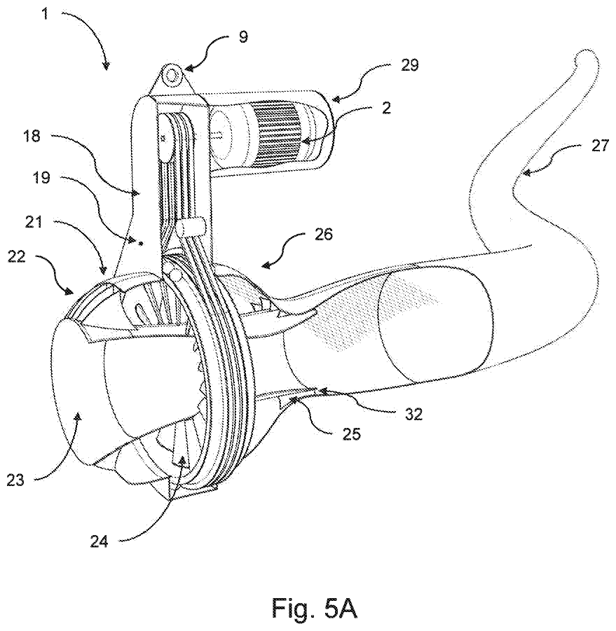

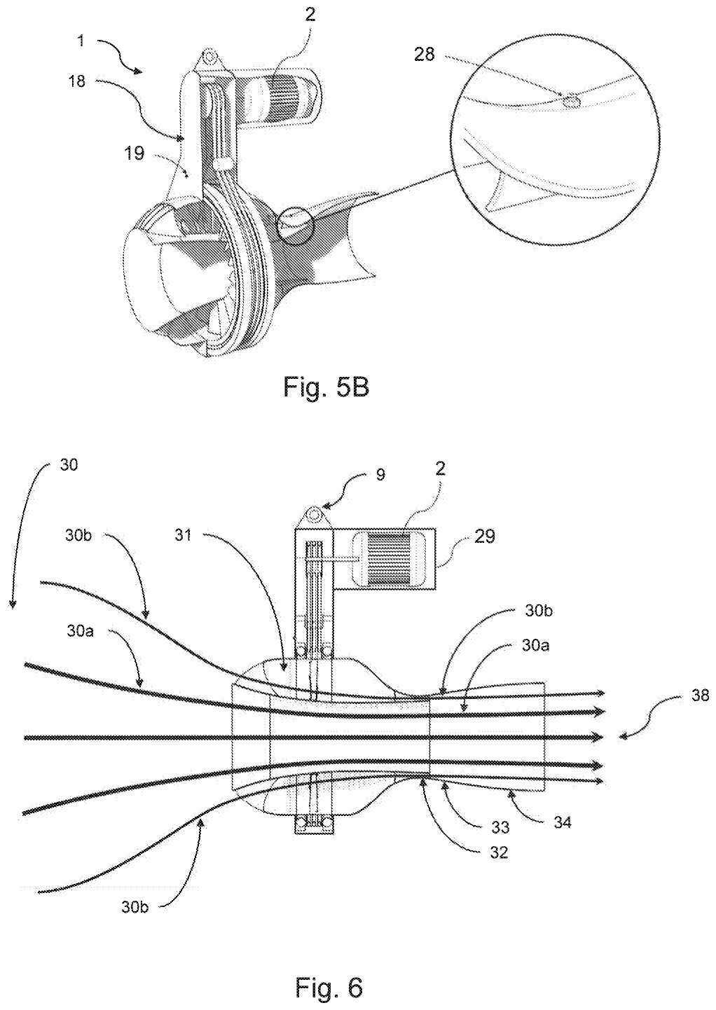

In another embodiment, illustrated in FIGS. 5A and 6, the fluid machine 1 is a submersible pump suitable for pumping, for example, fish or fluids comprising solid particles such as debris. FIG. 5A illustrates design aspects of the fluid machine, equivalent to FIG. 1 above, and FIG. 6 illustrates operational aspects, equivalent to FIG. 4 above. Various components of the fluid machine 1 which are equivalent to those described above are shown, and have the same characteristics and operate in the same manner as already described.

In this embodiment, the intake flow 30 enters the duct 23 directly when the fluid machine 1 is submerged in a liquid (and not via an intake pipe, as in the embodiments described above). A first flow 30b flows through the annular volume 31, where it is accelerated by the impeller 24, and a second flow 30a flows through the duct 23. The outlet flow 38 flows to the discharge pipe 27.

As above, a grid 22 (which may be a combined grid and guide vanes) can provided at the intake part 21 of the enclosure to prevent larger items (such as fish or debris) to enter the annular volume 31.

A suspension element 9, such as a hook receiver or a shackle, is provided to suspend or hang the fluid machine off, for example, a crane.

The discharge pipe 27 in this embodiment may be a flexible pipe, whereby the fluid machine 1 can be moved to the desired position substantially freely.

In this embodiment, the prime mover 2 may be enclosed in a sealed housing 29, such as to allow the entire fluid machine 1 to be submerged in the liquid to be pumped. Power and control signals to the prime mover 1 may then be provided through the sealed housing 29 via a water-tight extension through a wall of the sealed housing 29.

All other features described in relation to the embodiments shown in FIGS. 1-4 may further be relevant for this embodiment, either individually or in any combination.

In this embodiment, the requirements for the enclosure 18 to be fully water-tight may be relaxed, which eases the design of the unit and reduces the risk of operational downtime.

In some embodiments, for example the embodiment illustrated in FIGS. 1 to 6, one or more injection nozzles 28 may be arranged downstream the impeller 24. Such an injection nozzle 28 is illustrated in FIG. 5B. The injection nozzle 28 may be arranged, for example, at the annular nozzle 32, throat section 33, or diffuser section 34. Although FIG. 5B only illustrates one injection nozzle 28, more than one may be arranged, for example spaced radially around the annular nozzle 32. The injection nozzle 28 may thus be arranged such as to allow injection of a gas or fluid into the annular jet while the machine is operating.

The injection nozzle 28 may be utilised to inject, for example, oxygen or pharmaceutical agents into the process fluid. Positioning the injection nozzle 28 downstream the impeller 24 at the annular nozzle 32, throat section 33 or diffuser section 34 may ensure a thorough mixing into the entire fluid volume through the mixing of the first and second fluid flows which naturally occur in the throat and diffuser sections of the discharge part. The positioning of the injection nozzle 28 may thus be chosen to obtain optimal mixing, for example by means of fluid dynamics simulations or testing. Additionally or alternatively, injection of air or a gas into the annular jet may be used to directly modify the flow properties of the annular jet flow for example when it enters the throat and diffuser sections of the discharge part, in order to obtain a desirable flow field out of the fluid machine 1.

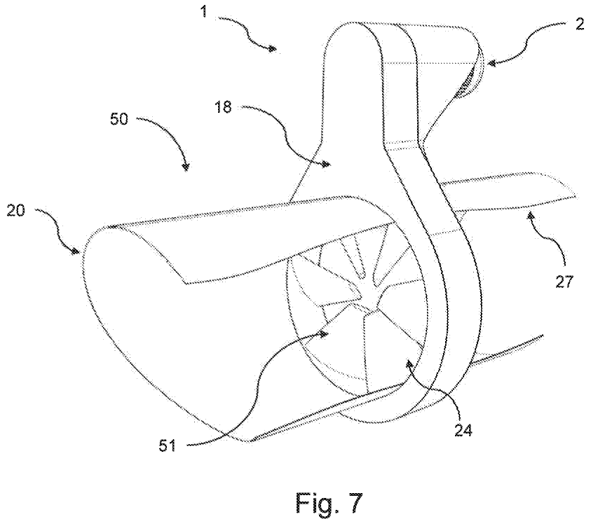

FIG. 7 shows another illustrative embodiment, wherein the fluid machine 1 is a thruster for a vessel, such as a ship or a boat. The fluid machine 1 is arranged in conjunction with a tunnel 50 which is made up of inlet and outlet pipes 20,27, wherein the impeller 24 (in thruster applications alternatively denoted “propeller”) comprises blades 51 and is operable to generate a water flow through the tunnel 50. A prime mover 2 drives the impeller/propeller 24 in the same manner as described above, and the driveline 90 may be configured in the same way as any of the embodiments described in relation to FIGS. 1-4.

In the embodiment shown in FIG. 7, the impeller/propeller 24 has an open centre, however the impeller/propeller 24 may alternatively not have an open centre such that the blades 51 are connected at the centre. As will be appreciated, in this embodiment, the fluid flow is not separated into first and second flows, as described above, but flows in a single flow stream through the impeller/propeller 24. The fluid machine 1 may otherwise comprise any of the individual features shown in relation to the embodiments described above, or any combination of such features.

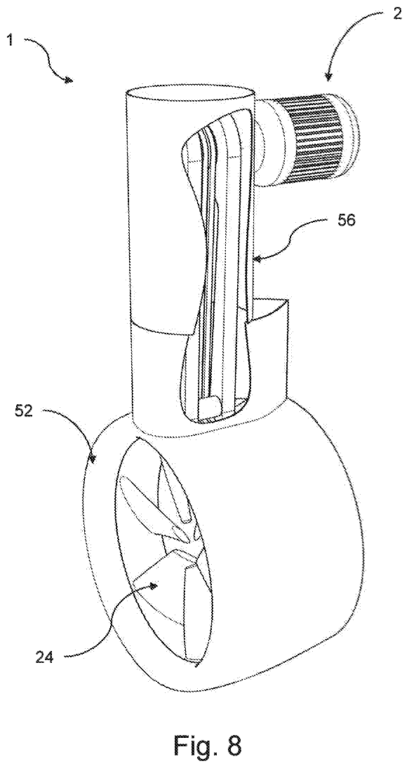

FIG. 8 illustrates another embodiment, in which the fluid machine 1 is an azimuth thruster for a vessel. The fluid machine 1 here comprises an impeller/propeller 24 with blades 51, a nozzle 52 formed as part of the enclosure 18, and a steering column 56 configured for connection to a ship hull.

In order to accommodate a greater distance between the impeller/propeller 24 and the prime mover 2, the belt layout is slightly different (a longer drive belt may be used), but otherwise the main operating principles may the same as those described in relation to the embodiments described above. In this embodiment, the combination of nozzle 52 and the neck/steering column 56 make up the watertight enclosure (item 18 in the other embodiments). The entire thruster can azimuth (i.e. rotate) about the central axis of neck/steering column 56. (The actuating mechanism and bearings for the azimuth function are not shown here, as these are well known components.)

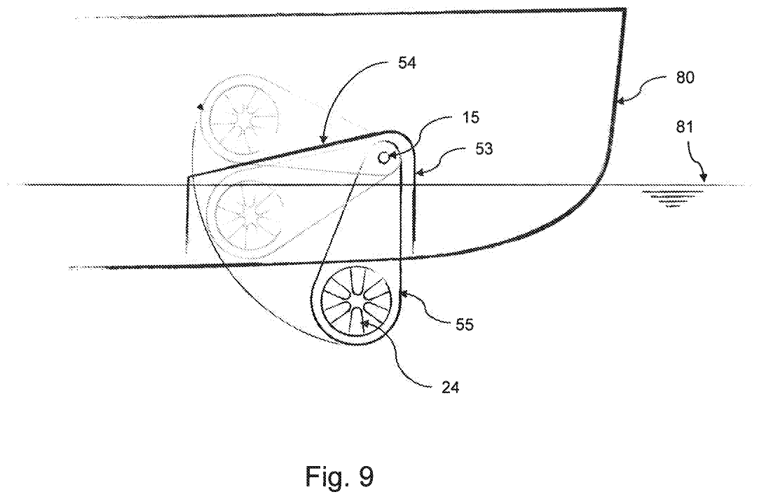

FIG. 9 shows another embodiment, wherein the fluid machine 1 is arranged in a vessel 80 and the impeller/propeller 24 is arranged on a support frame in the form of a centreboard 55 which is movable between a first position in which the impeller/propeller 24 is positioned outside a hull of the vessel 80, and a second position in which the impeller/propeller 24 is positioned inside the hull of the vessel 80. The first position is illustrated in FIG. 9 as the lowermost position of the centreboard 55 while the second position is illustrated as the middle position of the centreboard 55. The centreboard 55 is pivotable between the first and second positions about a shaft bearing 15 similarly as described above.

In this embodiment, the fluid machine 1 may operate as a thruster for the vessel 80 when in the first position, but may be retracted when not in use, such as to reduce hydrodynamic drag for the vessel 80. The centreboard 55 may be arranged in a sealed trunk 53 or the like in the hull of the vessel 80, which forms an enclosure for the impeller/propeller 24 and associated components similarly as above. The second position may be such that the centreboard 55 is below or partially below a waterline 81 when in the second position.

In one embodiment, the centreboard 55 has an additional third position, in which the centreboard 55 can be moved further into the hull of the vessel 80. The third position is illustrated in FIG. 9 as the uppermost position of the centreboard 55, and may be such that the impeller/propeller 24 and/or the centreboard 55 is partly or fully above the waterline 81 when in the third position. If the fluid machine 1 is arranged to be positioned in a trunk 53 in the second position, a removable hatch 54 in the trunk 53 may allow the fluid machine 1 to be moved into the third position. In the third position, inspections, repair, etc. may be carried out on the fluid machine 1.

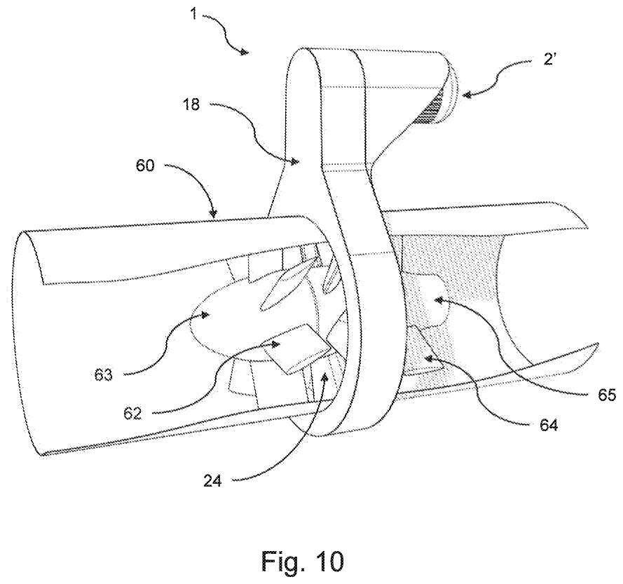

FIG. 10 illustrates a further embodiment, wherein the fluid machine 1 is a hydropower turbine arranged in a flow pipe 60. In this embodiment, a generator 2′ is connected to the impeller 24 so as to generate power from the fluid stream flowing past the fluid machine 1. The generator 2′ may be, for example, an electric generator of any suitable type, a mechanical pump or a compressor.

The fluid machine 1 may have flow guide elements, such as an upstream bulb 63 with guide vanes 62 to provide an advantageous flow field towards the impeller 24. The impeller 24 may be open-centred or not open-centred. A downstream bulb 65 with outlet guide vanes 64 may also be arranged downstream the impeller 24 to optimise performance.

The fluid machine 1 may otherwise be of the same design and comprise any of the individual features shown in relation to the embodiments described above, or any combination of such features. The driveline between the impeller 24 and the generator 2′, although in this embodiment operable to generate power from the fluid, may be arranged in the same manner.

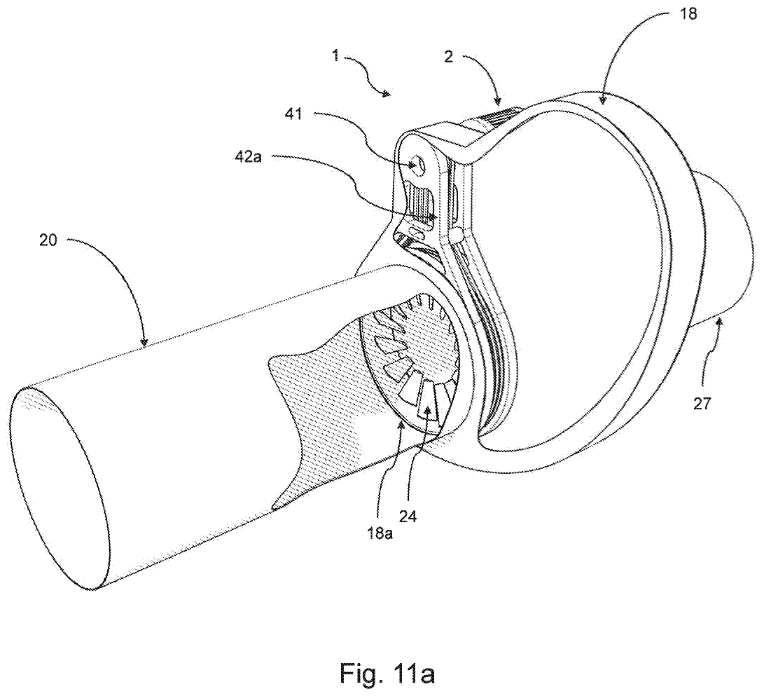

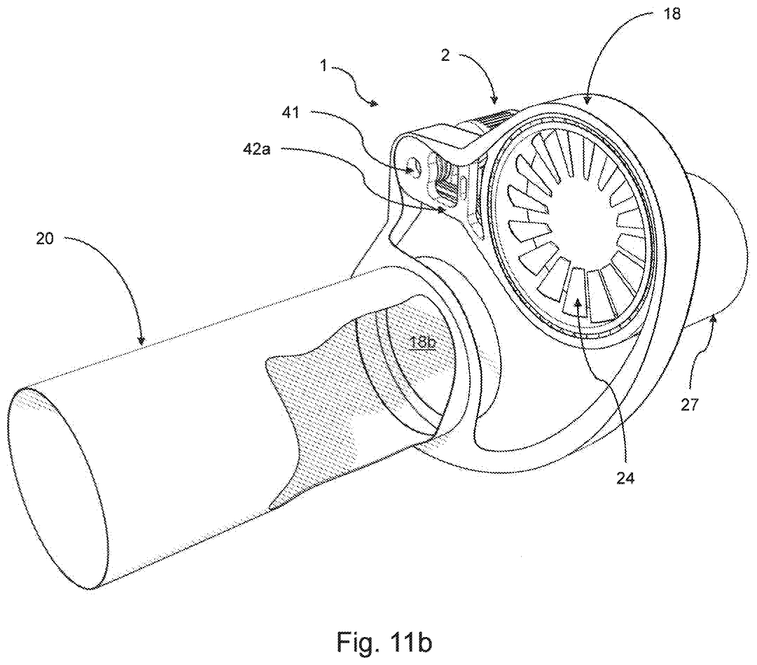

FIGS. 11a and 11b illustrate a further aspect, suitable for use with any of the embodiments described above. In FIGS. 11a and 11b, a thruster application similar to that shown in FIG. 7 is illustrated, however the fluid machine 1 may be any of the types described herein.

The enclosure 18 has a fluid inlet opening 18a connected to an inlet pipe 20 and a fluid outlet opening 18b connected to an outlet pipe 27. The impeller 24 is arranged on a support frame 42a arranged within the enclosure 18, and the support frame 42a is movable between a first position in which the impeller 24 is positioned between the inlet opening 18a and outlet opening 18b, i.e. aligned with the pipes 20,27 in a flow path defined by the inlet and outlet pipes 20,27, and a second position in which the impeller 24 is spaced from the flow path. FIG. 11a illustrates the support frame 42a in the first position and FIG. 11b illustrates the support frame 42a in the second position.

In this embodiment, the support frame 42a is connected to the enclosure 18 via a pivot bearing 41, and the support frame 42a is pivotable about an axis which extends through the pivot bearing 41. The axis may coincide with a central axis of the output shaft of the prime mover 2 or generator 2′. This may allow the prime mover 2 or generator 2′ to be spatially fixed in relation to the pipes 20,27 and other components, i.e. that the prime mover 2 or generator 2′ need not move with the support frame 42a. However the fluid machine may, alternatively, be arranged such that the prime mover 2 or generator 2′ moves with the support frame 42a.

While this embodiment shows a pivoting movement of the support frame 42a, it may alternatively be movable between the first and second positions in a different manner, for example by linear displacement.

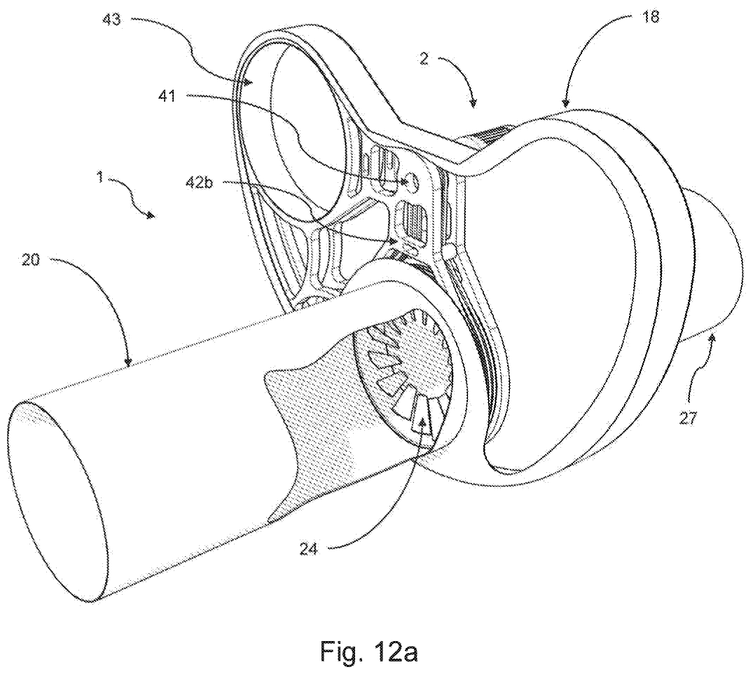

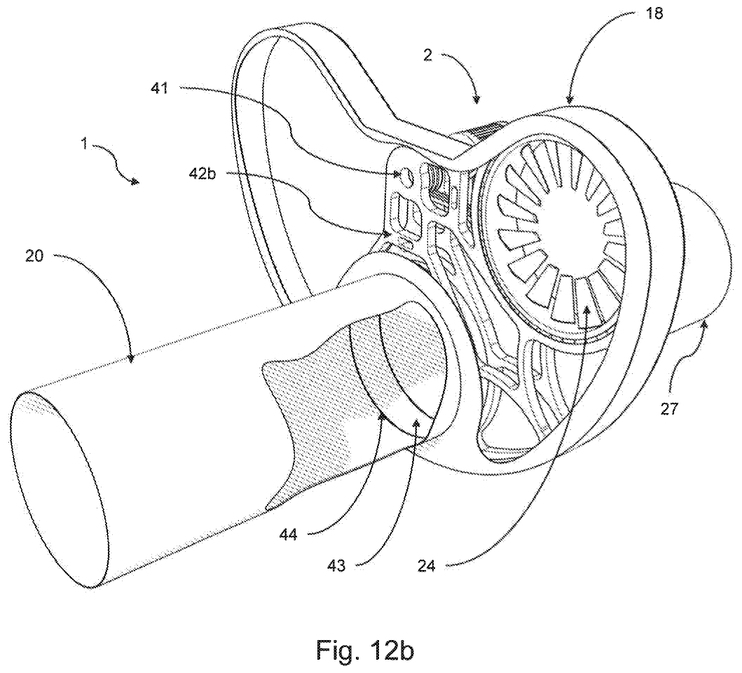

FIGS. 12a and 12b illustrate another embodiment, wherein the impeller 24 is arranged on a first part of the support frame 42b, which is pivotable about a pivot bearing 41 similarly as described above. The support frame 42b further comprises a bypass aperture 43 arranged on a second part of the support frame 42b. The bypass aperture 43 is in the second position aligned with the pipes 20,27, between the inlet and outlet openings 18a,b. FIG. 12a illustrates the first position, wherein the impeller 24 is aligned with the pipes 20,27 and FIG. 12b illustrates the second position, wherein the bypass aperture 43 is aligned with the pipes 20,27.

Alternatively, the second part of the support frame 42b may have a closed wall, such as to block the flow path between the pipes 20,27 when the support frame 42b is in the second position. In these embodiments, it is thereby possible to change the operational setting of the fluid machine 1 according to operational needs. For example, the bypass aperture 43 can be positioned between the pipes 20,27 to allow free flow of fluids through the pipes 20,27, or the closed wall can be positioned between the pipes 20,27 to prevent fluid flow.

The support frame 42b may be manually movable between the first and second positions by an operator, or it may comprise an actuator for driving the support frame 42b between the positions.

In some embodiments, other components of the system may also be fixed to the support frame 42a,b such as to be movable together with the support frame 42a,b. This may include, for example, the duct 23 in the pump application described in relation to FIGS. 1-4, and the bulbs and guide vanes 62-65 in the turbine application described in relation to FIG. 10. Alternatively, the impeller 24 and associated components may be arranged so as to allow the impeller 24 to be moved within the enclosure 18 with these other components remaining in place.

In one embodiment, the fluid machine 1 further comprises a seal system 44 arranged to isolate the interior of the enclosure 18 when in the second position. The seal system 44 may for this purpose seal between the intake and discharge pipes 20,27 and a face on the second part of the support frame 42b when in the second position. The seal system 44 may, for example, comprise seals arranged circumferentially around the end faces of the pipes 20,27. By means of the seal system 44, fluid in the pipes 20,27 can be prevented from flowing into the enclosure 18 when the support frame 42b is in the second position. This allows the enclosure 18 to be drained, and for example cleaning, inspection, maintenance or repairs to be carried out on the impeller, drive line or other components.

Direct access to the impeller 24 and associated components within the enclosure 18 may thus be possible without dismantling the entire enclosure 18 or the pipe system, for example via a hatch or a service door in the enclosure 18. In embodiments with a bypass aperture 43, the pipe system can continue to be operational during for example maintenance and operational downtime of the overall plant can be avoided. For example, if several fluid machines 1 are arranged in series, one fluid machine 1 may be subject to inspection or maintenance, while the others are still operational on the fluid flowing through the pipes 20,27.

Alternatively, or additionally, to that described above, the fluid machine 1 may be arranged such that the impeller 24 in the second position is positioned higher than the pipes 20,27. This may allow such access to the internal components in the enclosure 18 to be carried out with less risk of leakage, and less demands on the seal system 44. Depending on the fluid pressure in the pipes 20,27, this may in certain embodiments allow the enclosure 18 to be opened without a seal system 44. For example, if non-pressurized liquid stands in the pipes 20,27, the enclosure 18 may still be opened and accessed without draining down the pipes 20,27 entirely.

In a fish pump application, such as that illustrated in FIGS. 1-4, this feature may be particularly beneficial in view of hygienic requirements, whereby for example regular cleaning and/or disinfection of the impeller 24 and other components can be carried out effectively and regularly, without dismantling equipment. In turbine or thruster applications, similar benefits in terms of, for example, regular inspections or removal of marine growth can be achieved.

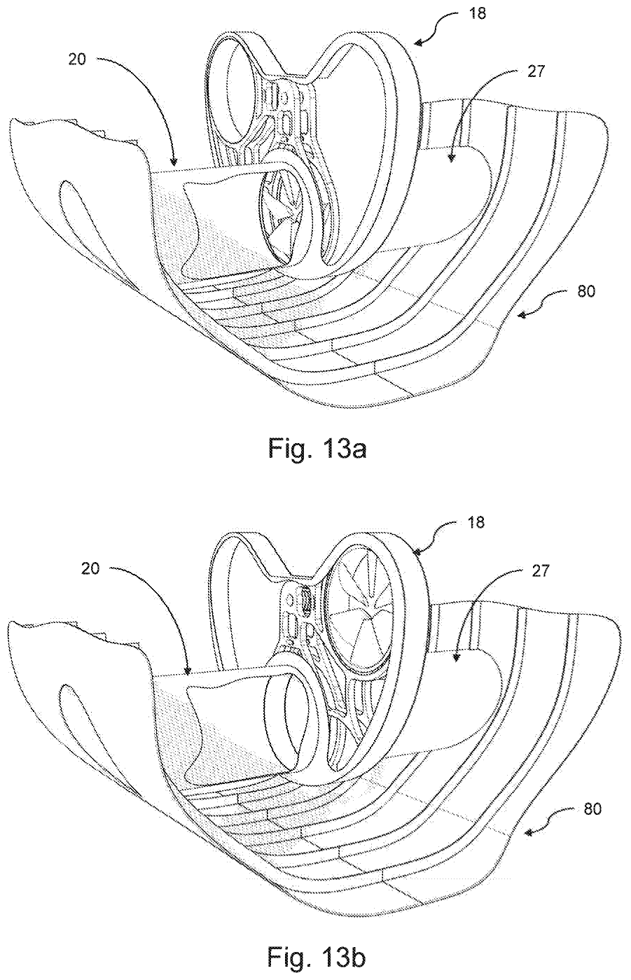

In a tunnel thruster application, such as that illustrated in FIG. 7, and with the use of a movable support frame 42b as shown in FIGS. 12a,b, this may allow that the impeller/propeller 24 in the second position is positioned below waterline of the ship and the tunnel is sealed watertight by the bypass aperture 43 and the seal system 44. This may allow the impeller/propeller 24 or other components to be for example inspected or serviced while moored or under way, without having to close off the openings of the tunnel 50 or ballast the ship to raise the tunnel above the waterline. This is illustrated in FIGS. 13a and 13b. In FIG. 13a, the thruster is in online/operation mode, with the impeller/propeller 24 aligned with the tunnel (equivalent to tunnel 50 shown in FIG. 7) which is made up of pipes 20,27. In this configuration, the fluid machine 1 operates as a regular thruster for the vessel 80. In FIG. 13b, the bypass aperture 43 is lined up with the tunnel. By means of the seal system 44, a complete watertight tunnel can be created when the bypass aperture 43 is in place and sealed off. The housing 18 may then, if desired, be drained down and access to the impeller/propeller 24 or associated components is possible.

Although the above illustrative embodiments are described with a view to operation in sea- or freshwater, it is to be understood that the invention is not limited to applications in water, as other process fluids may be of interest in other applications or markets.

In any of the embodiments described herein, the prime mover 2 or generator 2′ may be located in air (or an inert gas), and the driveline 90 and related components located inside the waterproof enclosure 18 submerged in a fluid. This may relax the need for a waterproof rating of the prime mover 2 or generator 2′, which may for example enable the use of low cost, standard machines. Having a waterproof enclosure 18 around the driveline 90 and associated components may allow the use of a simple, off-the-shelf shaft seal for the prime mover 2 or generator 2′, and avoid large-diameter, customized solutions for example for sealing around the impeller 24.

In any of the embodiments described herein, the prime mover 2 or generator 2′ may be located inside a watertight enclosure 29. This may allow the use of low cost, standard machines without waterproof rating also in applications where the entire machine is submerged, such as for example the embodiment shown in FIG. 5A.

In any of the embodiments described herein, the impeller 24 may be an open centre impeller. An open centre impeller may be an advantage in various applications, such as in a fluid pump for live fish or in a thruster for a vessel, where an open centre impeller/propeller may allow debris such as ropes, nets, etc. to pass through the impeller with less risk of entanglement and damage to the thruster.

In any of the embodiments described herein, the fluid machine 1 may be configured to handle a process fluid, and the bearings 14c may be configured to operate submerged in the process fluid. They bearings 14c may additionally be lubricated by the process fluid. The process fluid may, for example, be water.

In any of the embodiments described herein, the driveline 90 may be configured for operation submerged in the process fluid.

In any of the embodiments described herein, the prime mover 2 or the generator 2′ may be arranged vertically higher than, and optionally vertically above, the impeller 24. This may reduce the sealing requirements for the enclosure 18, particularly for the shaft seal between the prime mover 2/generator 2′ and the sheave 10. In some embodiments, for example if using a belt drive 12, this arrangement further allows the belt tension to partially carry and centre the mass of the impeller 24, and thereby reduce the load on the bearings.

In any of the embodiments described herein, the prime mover 2 or generator 2′, as well as the driveline 90, may be fixed to the enclosure 18 or may be carried by a dedicated support structure within the enclosure 18. This allows the enclosure 18 to provide structural support for these and associated components.

If large lifting heights or high flow volumes are required, several fluid machines according to any of the embodiments described herein can be operated in series.

In any of the embodiments described herein, the discharge pipe 27 can have an increasing cross-sectional area downstream the annular nozzle 32 (see e.g. FIGS. 1 and 4). This may contribute to generating a beneficial flow field and enhance the performance of the fluid machine when operating as a pump.

The duct 23 may have a cylindrical shape, having a constant cross-sectional area along its longitudinal extension. Fluid openings to the annular volume 31 may be provided as radial openings in the cylindrical duct. A cylindrically shaped duct 23 may ease manufacturing and assembly of the fluid machine.

The teaching herein thus provides fluid machines with simplified production and/or maintenance, with relaxed requirements for specialist skills for their manufacture, operation, maintenance and/or repairs. For example, if a belt drive transmission is used, a fault-tolerant system can be obtained, which is less sensitive to alignment errors. Additionally, or alternatively, embodiments which use standard electric or hydraulic motors may reduce cost and ensure highly reliable operation.

Some embodiments may provide solutions which reduce the risk of damage to the fluid machine itself, and/or to items being pumped, such as fish.

Some embodiments provide flexibility to design a compact machine with reduced requirements for external equipment or piping.

As will be appreciated when reading the disclosure, the principles described herein may be applicable to a wide range of applications and the invention is not limited to the embodiments described herein. Other applications may, for example, be a pump for pumping fluids comprising solids that may damage the impeller blades if coming into contact with them, or fluids comprising other elements which may, like fish, themselves be damaged if they come into contact with the impeller blades. For example, pumps for stripping (i.e. emptying) of ballast water or liquid cargo tanks in ships or removal of flood water which may contain debris are other examples of potentially suitable applications.

1. A fluid machine having an intake part, a discharge part, and an impeller,
the impeller being arranged in an enclosure, and
a transmission arranged in the enclosure and operationally connecting a rim of the impeller with an energy converter.

2. A fluid machine according to claim 1, wherein the energy converter is a motor, and wherein the impeller is arranged in an annular volume around a duct, wherein the duct defines a first fluid path through the fluid machine, and wherein the duct and the enclosure define a second fluid path through the annular volume and to an outlet downstream the impeller.

3. A fluid machine according to claim 2, wherein the fluid machine is a submersible pump and wherein the motor is arranged in a sealed housing.

4. A fluid machine according to claim 1, wherein the enclosure is a fluid-tight enclosure and the energy converter is arranged on the outside of the fluid-tight enclosure and coupled to the transmission via a sealed shaft connection.

5. A fluid machine according to claim 1 any preceding claim, wherein the fluid machine is configured to handle a process fluid, and the transmission is configured to operate submerged in the process fluid within the enclosure.

6. A fluid machine according to claim 1, wherein the energy converter is a generator and the fluid machine is a hydropower turbine configured to be arranged in a flow pipe.

7. A fluid machine according to claim 1, wherein the fluid machine is a thruster for a vessel.

8. A fluid machine according to claim 1, wherein the impeller is arranged on a support frame arranged within the enclosure, and the support frame is movable between
a first position in which the impeller is arranged between a fluid inlet opening and a fluid outlet opening of the enclosure, and
a second position in which the impeller is spaced from a volume between the fluid inlet opening and the fluid outlet opening.

9. A fluid machine according to claim 8, wherein the support frame is pivotable between the first and second positions about an axis, and wherein the axis coincides with a central axis of a shaft of the energy converter.

10. A fluid machine according to claim 8, wherein the support frame comprises a bypass aperture or a closed wall, and wherein the bypass aperture or closed wall in the second position is arranged between the fluid inlet opening and the fluid outlet opening.

11. A fluid machine according to claim 8, comprising a seal system arranged to isolate an internal volume of the enclosure from the fluid inlet opening and the fluid outlet opening when in the second position.

12. A fluid machine according to claim 1, the fluid machine comprising a bearing arranged within the enclosure and configured to provide radial and/or axial support of the impeller.

13. A fluid machine according to claim 12, wherein the fluid machine is configured to handle a process fluid, and the bearing is configured to operate submerged in the process fluid within the enclosure.

14. A fluid machine according to claim 1, comprising a seal arranged between the impeller and the enclosure.

15. A fluid machine according to claim 1, comprising an injection nozzle configured for injection of a fluid into the enclosure.

16. A fluid machine according to claim 1, wherein the energy converter is arranged vertically higher than the impeller, particularly wherein the energy converter is arranged vertically above the impeller.

17. A fluid machine according to claim 1, wherein the transmission is
a belt drive or a chain drive connecting the rim with a sheave of the energy converter, or
a gear drive between the rim and the energy converter.
